(19) United States
(12) Patent Application Publication
(10) Pub. No.: US 2015/0102881 A1
(43) Pub. Date: Apr. 16, 2015

(54) THREE-PHASE CHOKE

(71) Applicant: Wobben Properties GmbH, Aurich (DE)

(72) Inventor: Wojciech Giengiel, Aurich (DE)

(21) Appl. No.: 14/398,935

(22) PCT Filed: Apr. 24, 2013
(86) PCT No.: PCT/EP2013/058559

§ 371 Date: Nov. 4, 2014

(30) Foreign Application Priority Data
May 7, 2012 (DE) 10 2012 207 557.7

(51) Int. Cl. H01F 27/24; H02M 7/537

(52) U.S. Cl. CPC H01F 27/24; H02M 7/537
USPC 336/5; 363/131

(57) ABSTRACT

The invention concerns a magnetic core of a three-phase choke comprising a first, second and third magnetic leg for receiving a first, second and third electric winding respectively of a first, second and third electric phase respectively, wherein the first, second and third legs are arranged in a star or delta configuration.

### BACKGROUND

1. Technical Field

The present invention concerns a three-phase choke and a magnetic core for such a choke.

2. Description of the Related Art

Chokes in the electrical engineering sense are generally known. Depending on the respective application they provide a filtering action. In particular at the output of an inverter they serve to provide that a pulse width modulated current extends as sinusoidally as possible before it is fed into an electric supply network. Correspondingly here the respective choke is arranged between the inverter and the electric supply network into which the feed is to take place.

In the case of a three-phase system a choke is desired for each phase. Frequently such chokes of a three-phase system are combined together to give a three-phase choke. Provided for that purpose is a magnetic core which includes stacked sheet laminations which present for example the appearance of an 8 in a digital display. Thus there are three magnetically interconnected legs, which each carry a winding of a phase. A magnetic field which results from a current in a winding in the magnetic leg of that winding passes for a part thereof through the respective other two magnetic legs of the other two windings. In that way the magnetic fields of all three windings and thus all three phases are superimposed.

This approximately eight-shaped magnetic core has very high magnetic permeability so that the electric properties of the choke are substantially determined by the windings.

Such a magnetic core is comparatively simple to manufacture by virtue of the lamination of stamped sheets. A disadvantage however is that such a three-phase choke is not completely symmetrical because two coils are arranged on a respective outer magnetic leg, whereas one of the coils is arranged on a magnetic leg between the two outer legs. As a result the magnetic fields in the windings, more specifically in particular between the two outer windings on the one hand and the winding arranged centrally therebetween on the other hand, can differ. Possible leakage fields can occur and the magnetic reluctance which is effective in respect of the central winding can be somewhat less than the magnetic reluctance respectively effective for the two outer windings.

In addition such a three-phase choke presupposes a three-phase system in which the total of the currents is zero. In other words it presupposes a system, or is used in a system, which does not use or need a neutral conductor.

U.S. Pat. No. 6,452,819 discloses an inverter with an output choke having four legs, in which the fourth leg transmits asymmetrical magnetic fluxes from asymmetrical harmonics. The problem of asymmetries within the first three legs however cannot be resolved thereby.

The German Patent and Trade Mark Office searched the following state of the art in the priority application: DE 10 2008 031 296 A1, DE 10 74 146 A, DE 750 987 A, DE 412 872 A, U.S. Pat. No. 2,359,173 A, DE 20 2010 008 961 U1, U.S. 2,617, 090 A, U.S. Pat. No. 4,099,066 A, U.S. Pat. No. 1,157,730 A and EP 0 602 926 A1.

### BRIEF SUMMARY

An embodiment of the present invention is directed to an improved three-phase choke, which can also take account of an asymmetrical component of the three-phase system. The invention seeks at least to find an alternative solution.

According to one embodiment of the invention therefore there is proposed a magnetic core for a three-phase choke. Such a magnetic core has a first, second and third magnetic leg for receiving a first, second and third electric winding respectively of a first, second and third electric phase respectively, wherein the first, second and third legs are arranged in a star or delta configuration.

There are thus three, in particular, identical magnetic legs, which are arranged in a star configuration with respect to a common center point. In particular those three legs are oriented parallel to each other and parallel to a common longitudinal direction or longitudinal axis and have respective connecting legs which meet at a common center point. More specifically they are arranged in a star configuration with respect to that center point. In that respect those connecting legs in plan view, namely in a view along a longitudinal axis, are arranged approximately in a Y-shape. Preferably those three connecting legs in plan view are at an identical angle to each other, more specifically 120° in each case. In principle however different angles can also be provided. Correspondingly the three magnetic legs, namely the first, second and third magnetic legs, which can also be referred to as the main legs, are distributed uniformly around the common center point, more specifically being displaced each through 120° relative to each other, with respect to that center point.

The three main legs are arranged in a star configuration with respect to said center point. If they are connected directly by three notional lines, that results in a delta shape and in that respect the three main legs are arranged in a delta configuration. More specifically the three main legs are not arranged in a straight line relative to each other. Preferably the three main legs are so arranged that they form the corner point of a notional equilateral triangle.

That star-shaped or delta-shaped arrangement makes it possible to achieve a magnetic connection between the three main legs, that is the same in terms of kind and size. None of the three main legs assumes a special position, as was the case with the central leg in the state of the art. The proposed structure now permits the choke to be of a symmetrical configuration from the magnetic point of view.

Preferably there is provided a fourth magnetic leg and the first, second and third legs are arranged in a star configuration in relation to the fourth magnetic leg. The fourth magnetic leg can be adapted to receive a fourth winding. The fourth magnetic leg is preferably smaller than the first, second and third legs, that is to say smaller than the main legs. The fourth leg can carry a magnetic field which can occur by virtue of asymmetries in the three-phase system. These include in particular asymmetrical harmonics. Accordingly alternating magnetic fields of high frequency, in comparison with the frequency of the basic phase of the current of the three-phase system, can be expected in the fourth leg.

In particular therefore it can be provided that the fourth leg is in the form of a ferrite core or ferrite rod. Such a ferrite rod is suitable, in particular, for carrying high-frequency alternating magnetic fields. A winding can be provided on the fourth leg for carrying away or further processing such an asymmetrical component.

Preferably the first, second and third legs and optionally the fourth leg are arranged in mutually parallel relationship. They can be connected at two sides by way of three respective connecting legs connected together approximately in a Y-shape to give the magnetic core of the three-phase choke. In that case the fourth leg is provided as a central leg, if present, and both forms magnetically a center point and also in a mechanical aspect serves for stable connection of those two Y-shaped sets of connecting legs.

It is desirable if the first, second and third legs are arranged relative to each other at an equal first spacing and/or are arranged relative to the fourth leg at an equal second spacing, in order thereby to form a symmetry mechanically and magnetically.

Preferably therefore the first, second and third legs are respectively connected to the fourth magnetic leg by way of at least one magnetic connecting leg, in particular in each case by way of two magnetic connecting legs. Preferably the three main legs and the fourth leg extend parallel to each other and the connecting legs extend transversely, in particular at a right angle, relative thereto.

In an embodiment it is proposed that the first, second and third legs are connected magnetically in mutually parallel relationship. Preferably they are also connected in parallel with the fourth leg. In the ideal situation the three magnetic fields of the three main legs are superimposed to become zero in the fourth leg due to that parallel connection. Or, with that superimposition, in the fourth leg, there are only the asymmetrical components which can also be detected in a possible fourth winding of the fourth leg as a corresponding current and which can be carried away or cut in by way of suitable connection with a neutral conductor or in some other fashion.

In an embodiment it is proposed that the first and second legs form a part of a first magnetic circuit, the second and third legs form a part of a second magnetic circuit and the third and first legs form a part of a third magnetic circuit. Accordingly a magnetic field with a mean path length can be carried in each of those three magnetic circuits, wherein the first, second and third magnetic circuits are of an equal length, in particular are of the same mean path lengths of a respective magnetic field to be carried. In addition or alternatively they have the same magnetic reluctance, in particular without the provision of an air gap for that purpose.

The identical magnetic reluctance for each of those magnetic circuits is afforded, in particular, by all those three magnetic circuits involving the same mechanical structure while using identical materials. Accordingly it is also possible to demonstrate the feature that the magnetic circuits involve the same magnetic reluctance, by virtue of such an identical structure with identical materials.

In accordance with the invention there is proposed a three-phase choke provided with a magnetic core of a three-phase choke according to at least one of the described embodiments. Such a three-phase choke thus has a first, second and third magnetic leg carrying a first, second and third winding respectively of a first, second and third electric phase. Such a three-phase choke can thus implement the advantages and options which are made possible by the underlying magnetic core thereof.

Preferably the fourth magnetic leg carries a fourth winding and is adapted to carry an asymmetrical magnetic component of a three-phase system. In addition or alternatively the fourth winding is adapted to carry an asymmetrical electric component of a three-phase system. In particular the proposed solution provides a symmetrical three-phase choke in which any asymmetry components which occur in the fourth leg and/or which occur in the fourth winding are not governed by any asymmetries of the three-phase choke, but reflect actual asymmetries in the three-phase system.

Such a three-phase choke can be used in particular at the output of a frequency converter. Particularly if such a frequency converter is to be employed to provide a feed into a three-phase electric supply system. An asymmetrical loading occurs, governed by the functions involved, due to such a converter, in particular due to the IGBTs used there, and the three-phase choke, together with the proposed fourth leg, can take account of that loading. Particularly when connected to inverters or converters which generate zero currents, that is to say currents in a neutral conductor, that is to say a conductor additional to the three-phase conductors, it is possible to use such a three-phase choke.

In such an application a small zero current is finally produced in the fourth leg or in the winding of the fourth leg of a correspondingly connected three-phase choke, by virtue of actuation of the valves of a frequency converter, that is to say the semiconductor switches, such as, for example, the IGBTs. Hitherto three-phase chokes themselves were also responsible for asymmetrical components. A symmetrical three-phase choke, in particular of a star configuration as proposed, thus provides that only those asymmetrical currents occur, which are actually also produced by the converter, in particular actuation of the valves or semiconductor switches. Overall the asymmetry, namely the asymmetrical components, becomes less and correspondingly a loading on the semiconductor switches, that is to say the IGBTs, also becomes correspondingly uniform and accordingly less.

Non-optimum, at least non-uniform inductance distribution to individual phases of previous chokes is avoided.

In addition to the uniform loading which can be achieved in respect of the IGBTs, it is also possible to provide that a cooling surface of the copper of the windings is increased. In particular cooling of the winding is also uniform, with a uniform distribution of the main legs. In the case of a choke in accordance with the state of the art, in which three legs are arranged in a series, a worse cooling capability can be assumed to apply in respect of the central leg and thus the winding of the central leg.

Preferably the legs of the choke are respectively mechanically displaced through 120°. The magnetic spacings are also preferably identical from one leg to another, namely from one main leg to another. The fourth leg can consist of a ferrite core or a ferrite rod to take account of high-frequency alternating fluxes of low amplitude there.

At least one of the illustrated embodiments thus provides a symmetry, identical inductance values, and better air cooling, by virtue of larger free copper surface areas.

The use of different air gaps in known chokes in order thereby to render at least the magnetic reluctance of individual magnetic circuits uniform can be avoided.

### BRIEF DESCRIPTION OF THE SEVERAL VIEWS OF THE DRAWINGS

The invention is described in greater detail hereinafter by means of embodiments by way of example with reference to the accompany Figures.

FIG. 1 shows a perspective view illustrating the principle of a three-phase choke,

FIG. 2 shows a plan view illustrating the principle of a three-phase

choke, and

FIG. 3 shows a diagrammatic perspective view of a three-phase choke with indicated windings.

### DETAILED DESCRIPTION

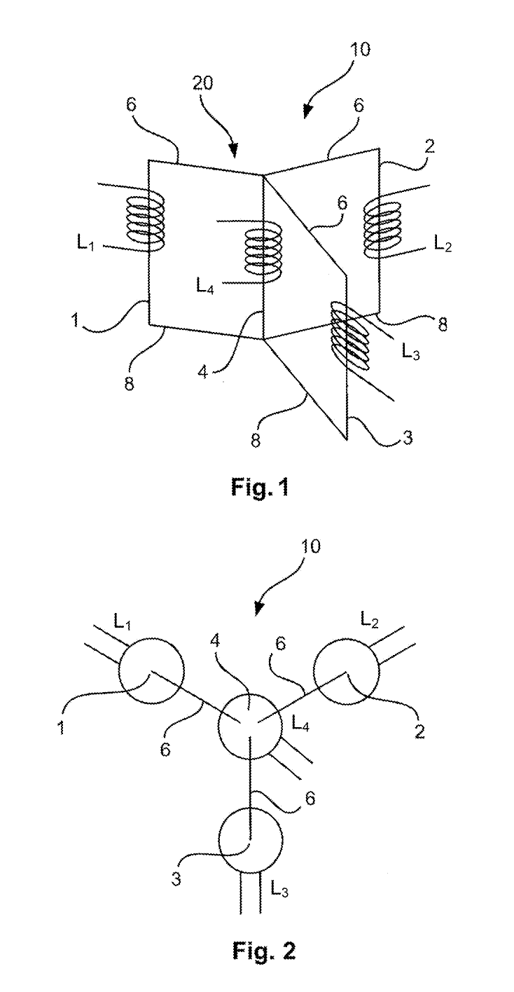

Hereinafter identical references can denote similar but possibly non-identical elements in order better to illustrate existing relationships. In particular FIGS. 1 and 2 are diagrammatic sketches which can therefore possibly deviate from an underlying subject and thus also from each other in regard to details of specific values like specific dimensions, without that being of significance for the described subject.

FIG. 1 shows a diagram illustration of a three-phase choke 10 with a magnetic core 20. The magnetic core 20 has a first magnetic leg 1, a second magnetic leg 2 and a third magnetic leg 3 which can also be referred to as the main legs 1, 2 and 3. The magnetic core 20 also has a fourth magnetic leg 4.

The three main legs 1, 2 and 3 are respectively connected to the fourth leg 4 by way of an upper connecting leg 6 and a lower connecting leg 8. Thus each of the three main legs 1, 2 and 3 is connected to each of the other two main legs 2, 3 and 3, 1 and 1, 2 respectively by way of two upper connecting legs 6 and two lower connecting legs 8. In any case, with a symmetrical mechanical design configuration and the use of the same material, the connection of the three main legs 1, 2 and 3 with each other and the connection of the three main legs 1, 2 and 3 to the fourth leg 4 is the same. All legs in FIG. 1, namely the three main legs 1, 2 and 3, the fourth leg and two connecting legs 6 and 8 are only diagrammatically shown as a line. In actual fact the three main legs 1, 2 and 3 are of the same thickness and the connecting legs 6 and 8, considered in themselves, are also of the same thickness. The fourth leg 4 at any event is markedly thinner than the main legs 1, 2 and 3.

In addition the first, second and third legs each carry a first, second and third winding L₁, L₂ and L₃ respectively, which can also be referred to as the main windings, while the fourth leg carries a fourth winding L₄. The three main windings L₁, L₂ and L₃ are of the same dimensions and the fourth winding L₄ can be of substantially smaller size than the three main windings L₁, L₂ and L₃. In particular the fourth winding L₄ can be of a markedly smaller configuration in regard to the number of turns and/or in respect of the line cross-section of each turn.

Preferably the three main windings L₁, L₂ and L₃ are respectively connected to a phase of a three-phase system. The fourth winding L₄ can be connected to a neutral conductor. The three upper connecting legs 6 are respectively arranged at an angle of 120° relative to each other. The same applies to the three lower legs 8. At the same time the lengths of the three upper connecting legs 6 and the three lower connecting legs 8 are the same and the three main legs 1, 2 and 3 are accordingly arranged symmetrically relative to each other and in that respect in particular in a star configuration around the fourth leg 4.

FIG. 2 diagrammatically shows a plan view of the three-phase choke 10 in FIG. 1. Here too it will be particularly clearly apparent that the three upper legs 6 are arranged at an identical angle relative to each other, namely 120°. Accordingly this gives a symmetrical arrangement of the three main windings L₁, L₂ and L₃ relative to each other. In this case the three main windings L₁, L₂ and L₃ are arranged mechanically uniformly around the fourth winding L₄. FIG. 2 shows in particular the star configuration of the arrangement of the three main legs 1, 2 and 3 which here only appear as a point at the end of the upper connecting leg 6 in question.

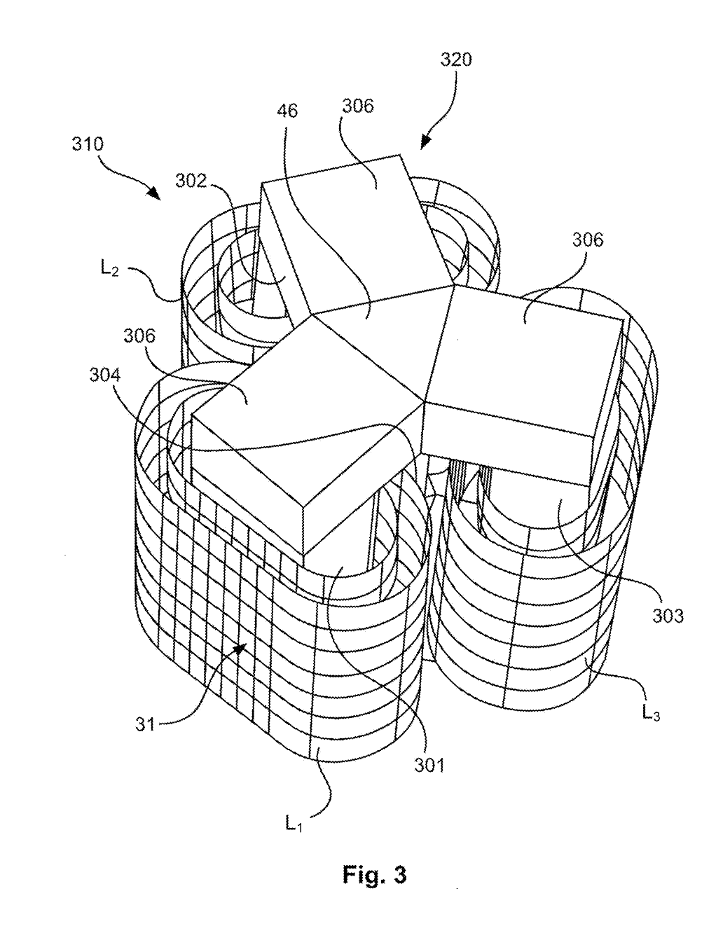

FIG. 3 in the perspective view shown demonstrates a possible specific configuration of a three-phase choke 310, in particular of the magnetic core 320. The magnetic core 320 has a first, second and third magnetic leg 301, 302 and 303. Each of those three magnetic legs 301, 302 and 303 has a winding L₁, L₂ and L₃ which however are only diagrammatically shown in that respect in order to clearly illustrate the required winding space or in general the required space needed for those windings L₁, L₂ and L₃. Accordingly it can be seen that each of the windings L₁, L₂ and L₃ has a great deal of identical space for irradiation of heat. In that respect, in particular at the winding L₁ it is possible to see a large irradiation surface 31 which is also present in the same size and kind in the two windings L₂ and L₃ but which can scarcely be seen in FIG. 3 and was therefore not provided with a reference numeral.

In addition there is a fourth leg 304. The fourth magnetic leg 304 is connected to a connecting central portion 46. The main legs 301, 302 and 303 are respectively connected with an upper connecting leg 306 to the central connecting central portion 46 and thus to the fourth leg 304. A corresponding structure is also to be found at the underside of the choke 310, which however can be only very vaguely seen in FIG. 3. The choke 10 and in particular the individual legs 301-304 are assembled and the respective magnetic circuit is also closed, by using stacked sheets of differing lengths. Mutual overlappings of the sheets affords a suitably durable connection and the desired magnetic circuit can be closed thereby.

Thus there is proposed a symmetrical three-phase choke 10 and 310, which is of a compact structure involving a symmetrical arrangement and thus symmetrical properties in regard to a three-phase system. Each phase of such a three-phase system is taken into account in the same way, in regard to the mechanical and thus thermally relevant structure. Any asymmetrical components are thus not produced by this three-phase choke 10 or 310, but can be taken into consideration in the fourth magnetic leg 4 or 304 respectively, and it is optionally possible to provide for conduction to a neutral conductor.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A magnetic core of a three-phase choke comprising:
a first, second, and third magnetic leg configured to receive a first, second, and third electric winding respectively, of a first, second, and third electric phase respectively; and
wherein the first, second, and third magnetic legs are arranged in a star or delta configuration.

2. The magnetic core of claim 1 further comprising a fourth magnetic leg configured to receive a fourth winding, the fourth magnetic leg being central to the first, second and third magnetic legs, the first, second, and third magnetic legs being arranged in a star configuration in relation to the fourth magnetic leg.

3. The magnetic core of claim 1 wherein the first, second, and third magnetic legs have respective axes that extend parallel to each other.

4. The magnetic core of claim 1 wherein the first, second, and third magnetic legs are arranged equidistance from each other

5. The magnetic core of claim 2 wherein the first, second, and third legs are, respectively, coupled to the fourth magnetic leg by way of at least one magnetic connecting leg.

6. The magnetic core of claim 1 wherein the first, second, and third magnetic legs are magnetically coupled in a mutually parallel relationship.

7. The magnetic core of claim 1 wherein:
the first and second magnetic legs form a part of a first magnetic circuit;
the second and third magnetic legs form a part of a second magnetic circuit;
the third and first magnetic legs form a part of a third magnetic circuit, and
wherein the first, second and third magnetic circuits have at least one of an equal length and a same magnetic reluctance.

8. A three-phase choke comprising;
a magnetic core including:
a second magnetic leg carrying a second winding; and
a second magnetic leg carrying a second winding; and
a third magnetic leg carrying a third winding, wherein the first second, and third magnetic legs are arranged in a star configuration about a central axis.

9. The three-phase choke of claim 8 further comprising a fourth magnetic leg carrying a fourth windings wherein the fourth magnetic leg is adapted to carry an asymmetrical magnetic component of a three-phase system and/or and the fourth winding is adapted to carry an asymmetrical magnetic component of a three-phase system.

10. The three-phase choke of claim 9 wherein:
the choke is coupled to an output of an inverter; and
the fourth winding is coupled to a neutral conductor.

11. The three-phase choke of claim 9, wherein the fourth magnetic leg is a ferrite rod.

12. The three-phase choke of claim 9 wherein the fourth magnetic leg is shorter than the first, second, and third magnetic legs.

13. An arrangement for feeding electric current into an electric supply network, the arrangement comprising:
an inverter; and
a three-phase choke arranged between the inverter and the electric supply network,
wherein the three-phase choke includes a magnetic core having:
a first magnetic leg carrying a first winding;
a second magnetic leg carrying a second winding; and
a third magnetic leg carrying a third winding, wherein the first, second and third magnetic legs are arranged in a star or delta configuration about a central axis.

14. The arrangement of claim 13 wherein the fourth winding is coupled to a neutral conductor.

15. The arrangement of claim 13 further comprising:
a fourth magnetic leg that has a longitudinal axis that extends along the central axis, the fourth magnetic leg carrying a fourth winding, wherein the fourth magnetic leg and the fourth winding are configured to carry an asymmetrical electric component of the three-phase choke.

16. The magnetic core of claim 2 wherein the fourth magnetic leg is a ferrite core.

17. The magnetic core of claim 2 wherein the first, second, and third magnetic legs are arranged equidistance from the fourth magnetic leg.

18. The magnetic core of claim 5 wherein the first, second, and third magnetic legs are, respectively, coupled to the fourth magnetic leg by way of two magnetic connecting legs.
